(19) United States
(12) Patent Application Publication
(10) Pub. No.: US 2026/0290250 A1
(43) Pub. Date: Sep. 24, 2026

(54) DISPLAY MODULE AND ELECTRONIC DEVICE

(71) Applicant: Samsung Display Co., Ltd., Yongin-si (KR)

(72) Inventors: Jaekeun LIM, Yongin-si (KR); Kyung-Woo KIM, Yongin-si (KR); Cheolmin KIM, Yongin-si (KR); Hae-Kwan SEO, Yongin-si (KR)

(73) Assignee: Samsung Display Co., Ltd., Yongin-si (KR)

(21) Appl. No.: 19/442,331

(22) Filed: Jan. 7, 2026

(30) Foreign Application Priority Data
Mar. 20, 2025 (KR) 10-2025-0035956

(51) Int. Cl. G09G 3/3266; G09G 3/3275

(52) U.S. Cl. CPC G09G 3/3266; G09G 3/3275; G09G 2320/0233; G09G 2330/021

(57) ABSTRACT

A display module may include a display panel including a plurality of pixels respectively connected to a plurality of data lines and a plurality of scan lines, a data drive circuit configured to drive the plurality of data lines; a first scan drive circuit configured to drive a first plurality of scan lines of the plurality of scan lines, and a second scan drive circuit configured to drive a plurality of second scan lines of the plurality of scan lines. During a multi-frequency mode, the display panel is divided into a first display region driven at a first drive frequency and a second display region driven at the second drive frequency, the first scan drive circuit is configured to set a drive frequency of the first plurality of scan lines in a boundary area of the second display region to a third drive frequency, and the second scan drive circuit is configured to set a drive frequency of the second plurality of scan lines in the boundary area to a fourth drive frequency.

### CROSS-REFERENCE TO RELATED APPLICATIONS

This application claims priority under 35 U.S.C. § 119 to Korean Patent Application No. 10-2025-0035956, filed on Mar. 20, 2025, in the Korean Intellectual Property Office, the disclosure of which is incorporated by reference herein in its entirety.

### BACKGROUND

The present disclosure relates to a display module for displaying an image and an electronic device including the same.

An electronic device such as a television, a mobile phone, a tablet computer, a navigation system, a game machine, or the like generates an image and provides the generated image to a user through a display module.

A display module of an electronic device includes a plurality of pixels and drive circuits that control an image to be displayed in the plurality of pixels. Each of the plurality of pixels includes a light-emitting element and transistors that control the light-emitting element.

### SUMMARY

One or more embodiments of the present disclosure provide a display module and an electronic device capable of reducing power consumption.

In one or more embodiments of the present disclosure, a display module may include a display panel including a plurality of pixels respectively connected to a plurality of data lines and a plurality of scan lines, a data drive circuit configured to drive the plurality of data lines; a first scan drive circuit configured to drive a first plurality of scan lines of the plurality of scan lines, and a second scan drive circuit configured to drive a plurality of second scan lines of the plurality of scan lines. During a multi-frequency mode, the display panel is divided into a first display region driven at a first drive frequency and a second display region driven at the second drive frequency, the first scan drive circuit is configured to set a drive frequency of the first plurality of scan lines in a boundary area of the second display region to a third drive frequency, and the second scan drive circuit is configured to set a drive frequency of the second plurality of scan lines in the boundary area to a fourth drive frequency.

In one or more embodiments of the present disclosure, an electronic device may include: a processor configured to provide an image signal and a control signal; and a display module configured to determine an operation mode based on the image signal and the control signal, and display an image according to the operation mode. The display module may include: a display panel including a plurality of pixels respectively connected to a plurality of data lines and a plurality of scan lines; a data drive circuit configured to drive the plurality of data lines; a first scan drive circuit configured to drive a first plurality of scan lines of the plurality of scan lines; a second scan drive circuit configured to drive a second plurality of scan lines of the plurality of scan lines, and a drive controller configured to control the data drive circuit, the first scan drive circuit, and the second scan drive circuit based on the image signal and the control signal. Based on the operating mode being a multi-frequency mode: the display panel is divided into a first display region driven at a first drive frequency and a second display region driven at the second drive frequency, the first scan drive circuit is configured to set a drive frequency of the first plurality of scan lines in a boundary area of the second display region to a third drive frequency, and the second scan drive circuit is configured to set a drive frequency of the second plurality of scan lines in the boundary area to a fourth drive frequency.

### BRIEF DESCRIPTION OF DRAWINGS

The above and other objects and features of the present disclosure will become apparent by describing in detail embodiments thereof with reference to the accompanying drawings.

FIG. 1 is a block diagram of an electronic device according to an embodiment.

FIG. 2 is schematic diagrams of electronic devices according to various embodiments.

FIG. 3 illustrates an electronic device according to an embodiment of the present disclosure.

FIGS. 4A and 4B are perspective views of an electronic device according to an embodiment of the present disclosure.

FIG. 5A is a diagram for describing an operation of an electronic device in a single frequency mode.

FIG. 5B is a diagram for describing an operation of an electronic device in a multi-frequency mode.

FIG. 6 is a block diagram of a display module according to an embodiment of the present disclosure.

FIG. 7 is a circuit diagram of a pixel according to an embodiment of the present disclosure.

FIG. 8 is a block diagram illustratively showing the first drive circuit shown in FIG. 6.

FIG. 9 is a block diagram illustratively showing the second drive circuit shown in FIG. 6.

FIG. 10 illustratively shows scan signals in single frequency mode and multi-frequency mode.

FIG. 11 illustrates an electronic device according to an embodiment of the present disclosure.

FIG. 12 illustratively shows scan lines arranged in the first boundary region.

FIG. 13 is a graph illustratively showing luminance of a first boundary region according to a drive frequency of each of first groups and second groups of the first boundary region.

FIG. 14 exemplarily shows the luminance of the first boundary region when driving the first scan lines and the second scan lines in the manner shown in FIG. 12.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

In the present disclosure, it will be understood that when an element (or a region, a layer, a portion, or the like) is referred to as being “on”, “connected to” or “coupled to” another element, it can be directly arranged on, connected to, or coupled to the other element or layer or other elements may be arranged therebetween.

Like reference numerals or symbols refer to like elements throughout. In the drawings, the thickness, ratio, and size of the elements are exaggerated for effectively describing the technical contents. As used herein, the term “and/or” includes any and all combinations of one or more of the associated listed elements

It will be understood that, although the terms “first”, “second”, etc. may be used herein to describe various elements, the elements are not to be limited by these terms. These terms are only used to distinguish one element from another element. For instance, a first element discussed below could be termed a second element without departing from the scope of the inventive concept. Similarly, a second element could be termed a first element. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components, or combinations thereof, but do not preclude the possibility of the presence or addition of one or more other features, numbers, steps, operations, elements, components, and/or combinations thereof.

In the present disclosure, the term “an embodiment” is intended to encompass one or more embodiments, rather than being limited to a single example. Furthermore, features described in embodiments may be combined and implemented together.

Unless otherwise defined, all terms (including technical and scientific terms) used herein have the same meaning as commonly understood by one of ordinary skills in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to the drawings.

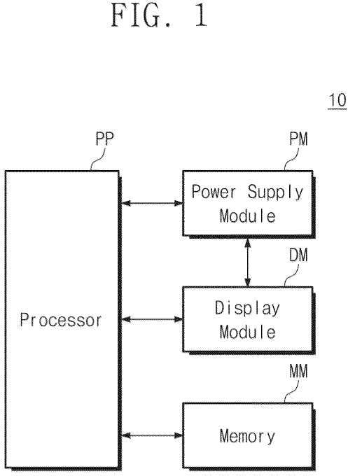

FIG. 1 is a block diagram of an electronic device 10 according to an embodiment.

Referring to FIG. 1, an electronic device 10 according to an embodiment may include a display module DM, a processor PP, a memory MM, and a power supply module PM.

The processor PP may include at least one of a central processing unit (CPU), an application processor (AP), a graphics processing unit (GPU), a communication processor (CP), an image signal processor (ISP), and a controller.

The memory MM may store data information necessary for the operation of the processor PP or the display module DM. When the processor PP executes an application stored in the memory MM, an image data signal and/or an input control signal are transmitted to the display module DM, and the display module DM may process the received signal and output image information through a display screen.

The power supply module PM may include a power supply module such as a power adapter or a battery device, and a power conversion module that converts power supplied by the power supply module to generate power required for operation of the electronic device 10.

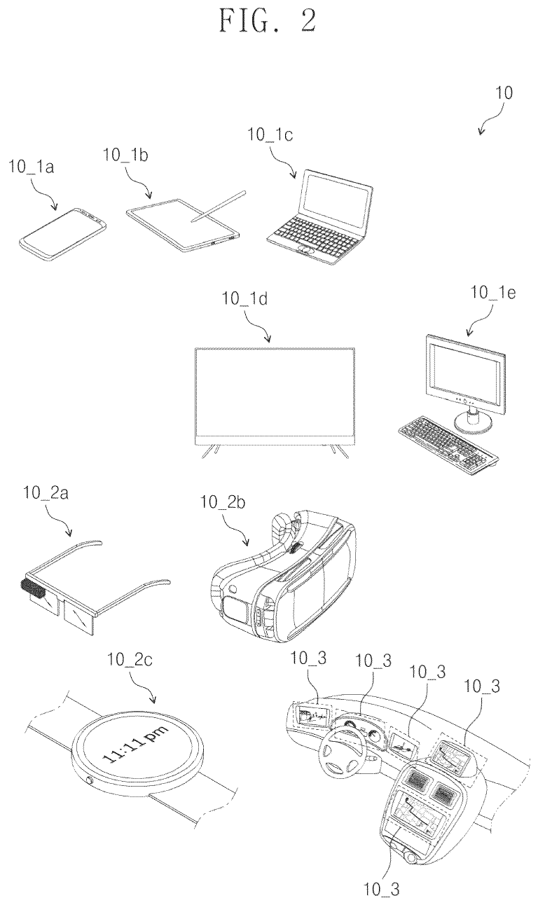

FIG. 2 is schematic diagrams of electronic devices according to various embodiments.

Referring to FIG. 2, various electronic devices according to embodiments may include an electronic device for displaying an image such as a smartphone 10_1a, a tablet PC 10_1b, a laptop 10_1c, a TV 10_1d, and a desk monitor 10_1e, and the like, as well as a wearable electronic device including a display module such as smart glasses 10_2a, a head mounted display 10_2b, a smart watch 10_2c, and the like, an electronic device for a vehicle 10_3 including a display module, such as a center information display (CID), a room mirror display, and the like arranged on an instrument panel, a center fascia, and a dashboard of a vehicle, and the like.

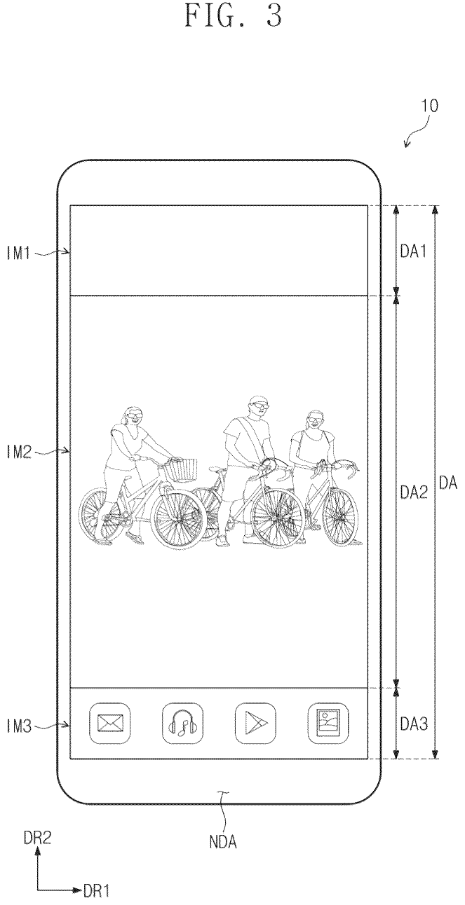

FIG. 3 illustrates an electronic device according to an embodiment of the present disclosure.

FIG. 3 illustrates a portable terminal as an example of the electronic device 10 according to an embodiment of the present disclosure. The portable terminal may include tablet computers, smartphones, personal digital assistants (PDAs), portable multimedia players (PDAs), game machines, a wrist-watch-type electronic devices, and the like. However, the present disclosure is not limited thereto. The electronic device 10 may be implemented as large electronic equipment such as televisions or external billboards, as well as small and medium-sized electronic equipment such as personal computers, notebook computers, kiosks, car navigation units, cameras, and the like. These are merely examples, and can be employed in other electronic devices without departing from the concept of the present disclosure.

As illustrated in FIG. 3, a display surface of the electronic device 10 on which the first image IM1 and the second image IM2 are displayed is parallel to a plane defined by the first direction DR1 and the second direction DR2. The display surface is divided into a plurality of regions, including a display area DA in which the first image IM1 and the second image IM2 are displayed, and a non-display area NDA adjacent to the display area DA. The non-display area NDA may be referred to as a bezel area. As an example, the display area DA may have a rectangular shape. The non-display area NDA surrounds the display area DA. Further, the electronic device 10 may include portions with a curved shape.

The display area DA of the electronic device 10 includes a first display area DA1, a second display area DA2, and a third display area DA3. The first display area DA1, the second display area DA2, and the third display area DA3 may be sequentially arranged in a direction opposite to the second direction DR2.

In a specific application program, the first image IM1 may be displayed in the first display area DA1 and the third display area DA3, and the second image IM2 may be displayed in the second display area DA2, which is positioned between the first display area DA1 and the third display area DA3. For example, the first image IM1 may correspond to static content (e.g., a still image), such as a photograph, an icon, or text information, which is characterized by a low update or refresh late (i.e., a long change period). The second image IM2 may correspond to dynamic content (e.g., a moving image), such as a video or an animated graphic, which requires a high updated rater due to a rapid frame changes (e.g., a short change period). The electronic device 10 may store a predetermined refresh rate threshold or change period threshold to determine whether a given image constitutes static content. Based on this determination, the device identifies whether the image corresponds to the first image IM1, which is to be displayed in the first display area DA1 or the third display area DA3, or the second image IM2, to be displayed in the second display area DA2.

The operation mode of the electronic device 10 may include a single frequency mode and a multi-frequency mode. The electronic device 10 may drive all of the first display area DA1, the second display area DA2, and the third display area DA3 at a base frequency during the single frequency mode. The electronic device 10 according to an embodiment may drive the first display area DA1 and the third display area DA3 in which the first image IM1 is displayed at a first drive frequency and drive the second display area DA2 in which the second image IM2 is displayed at a second drive frequency during the multi-frequency mode. In an embodiment, the first drive frequency may be lower than or equal to the base frequency. In one embodiment, the second drive frequency may be higher than the first drive frequency. In an embodiment, the second drive frequency may be higher than or equal to the base frequency. The electronic device 10 may reduce power consumption by lowering drive frequency of the first display area DA1 and the third display area DA3 in which a still image is displayed. The electronic device 10 can improve display quality by maintaining a high drive frequency of the second display area DA2 in which a moving image is displayed. This regional frequency modulation allows the electronic device 10 to optimize power efficiency and display performance. By reducing the refresh rate for regions displaying static images, power consumption is minimized. At the same time, maintaining a high refresh rate for the region displaying dynamic content ensures smooth motion rendering and improved visual quality.

Sizes and positions of each of the first display area DA1, the second display area DA2, and the third display area DA3 may be predefined according to device specifications or default display layouts. However, in certain embodiments, these parameters may be dynamically adjusted based on user settings or application program requirements. For example, an app may resize second display area DA2 to expand the video playback region, or a user may configure a multi-window layout with custom-defined sub-area boundaries.

In an embodiment, the display area DA may be divided into two or more display areas, and a drive frequency of each of the display areas may be determined according to a type of the image (the still image or the moving image) displayed in each of the display area.

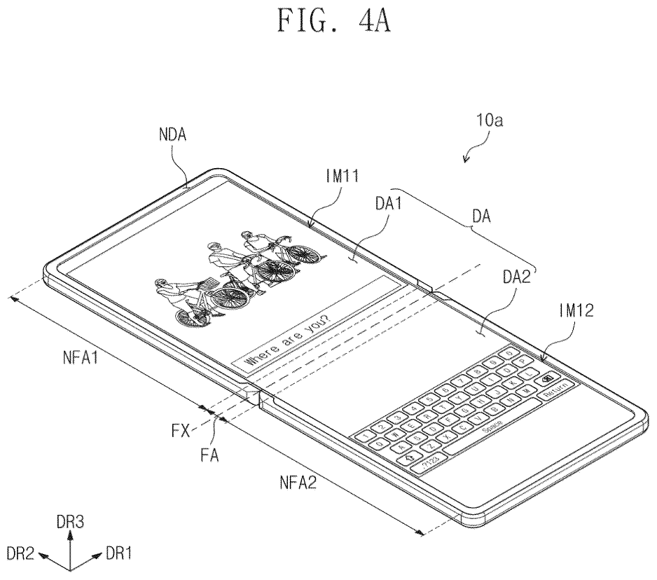

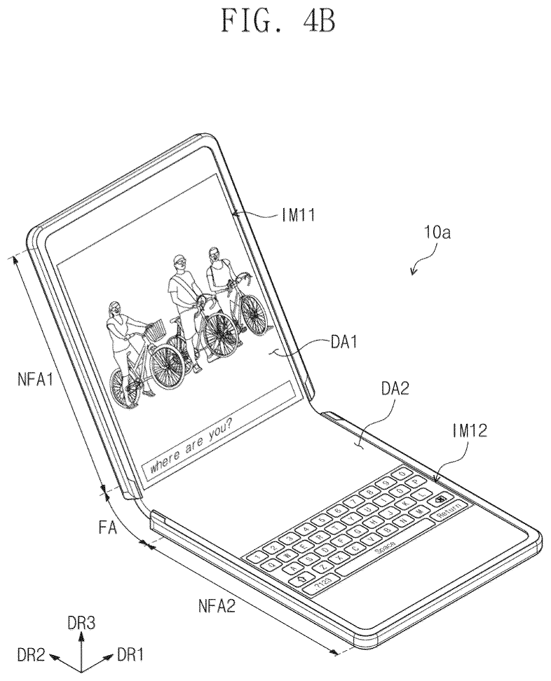

FIGS. 4A and 4B are perspective views of the electronic device 10 according to an embodiment of the present disclosure. FIG. 4A illustrates an unfolded state of the electronic device 10a, and FIG. 4B illustrates a folded state of the electronic device 10a.

As illustrated in FIGS. 4A and 4B, the electronic device 10a includes a display area DA and a non-display area NDA. The electronic device 10a may display an image through the display area DA. In a state where the electronic device 10a is unfolded, the display area DA may include a plane defined by a first direction DR1 and a second direction DR2. The thickness direction of the electronic device 10a may be parallel to a third direction DR3 intersecting the first direction DR1 and the second direction DR2. Therefore, the front surface (or the upper surface) and the rear surface (or the lower surface) of the components constituting the electronic device 10a may be defined with reference to the third direction DR3. The non-display area NDA may be referred to as a bezel area. As an example, the display area DA may have a rectangular shape. The non-display area NDA surrounds the display area DA.

The display area DA may include a first non-folding area NFA1, a folding area FA, and a second non-folding areas NFA2. The folding region FA may be bent with respect to the folding axis FX extending along the first direction DR1.

When the electronic device 10a is folded, the first non-folding region NFA1 and the second non-folding area NFA2 may be positioned to face each other. Thus, in the fully folded state, the display area DA may be concealed within the folded structure, rendering it not visible from the outside. This configuration is referred to as in-folding. However, this is exemplary, and the folding operation of the electronic device 10a is not limited thereto.

In an embodiment of the present disclosure, when the electronic device 10a is folded, the first non-folding region NFA1 and the second non-folding area NFA2 may be arranged to oppose to each other, and at least one of them remains exposed to the outside. In this configuration, which is referred to as out-folding, the folded device maintains external visibility of at least part of the display or housing.

The electronic device 10a may be configured to support only one folding type, either in-folding or out-folding. Alternatively, the electronic device 10a may be configured to support both folding types, enabling the same folding area FA to undergo the in-folding operation and the out-folding operation. In some embodiments, hybrid folding may be implemented, in which some regions of the electronic device 10a may be in-folded, while some other regions may be out-folded.

Although one folding region and two non-folding regions are illustrated in FIGS. 4A and 4B by way of example, the number of folding and non-folding regions is not limited thereto. For example, the electronic device 10a may include more than two non-folding regions and a plurality of folding regions arranged between non-folding areas adjacent to each other.

Although FIGS. 4A and 4B exemplarily show that the folding axis FX is parallel to the minor axis of the electronic device 10a, the present disclosure is not limited thereto. For example, the folding axis FX may extend along a long axis of the electronic device 10a, for example, a direction parallel to the second direction DR2

Although FIGS. 4A and 4B exemplarily show that the first non-folding region NFA1, the folding region FA, and the second non-folding area NFA2 are sequentially arranged along the second direction DR2, the present disclosure is not limited thereto. For example, the first non-folding region NFA1, the folding region FA, and the second non-folding area NFA2 may be sequentially arranged along the first direction DR1.

A plurality of display areas DA1 and DA2 may be defined in the display area DA of the electronic device 10a. Although two display regions DA1 and DA2 are exemplarily illustrated in FIG. 4A, the number of the plurality of display regions DA1 or DA2 is not limited thereto.

The plurality of display areas DA1 and DA2 may include a first display area DA1 and a second display area DA2. For example, the first display area DA1 may be an area where the eleventh image IM11 is displayed, and the second display area DA2 may be an area in which the twelfth image IM12 is displayed. For example, the eleventh image IM11 may be a moving image, and the twelfth image IM12 may be a still image.

The electronic device 10a according to an embodiment may operate differently depending on an operation mode. The operation mode of the electronic device 10a may include a single frequency mode and a multi-frequency mode.

The electronic device 10a may drive both the first display area DA1 and the second display area DA2 at a base frequency during the single frequency mode. The electronic device 10a according to an embodiment may drive the first display area DA1 in which the eleventh image IM11 is displayed at a first drive frequency and drive the second display area DA2 in which the twelfth image IM12 is displayed at a second drive frequency during the multi-frequency mode. In an embodiment, the first drive frequency may be higher than or equal to the base frequency, and the second drive frequency may be lower than the base frequency.

The size of each of the first display area DA1 and the second display area DA2 may be a preset size and may be changed by an application program. In an embodiment, the first display area DA1 may correspond to the first non-folding area NFA1, and the second display area DA2 may correspond to the second non-folding areas NFA2. In addition, a first portion of the folding area FA may correspond to the first display area DA1, and a second portion of the folded area FA may correspond to the second display area DA2.

In an embodiment, the entire folding areas FA may correspond to only one of the first display area DA1 and the second display area DA2.

In an embodiment, the first display area DA1 may correspond to a first portion of the first unfolded area NFA1, and the second display area DA2 may correspond to a second portion of the first unfolded area NFA 1, the folded area FA, and the second unfolded area NFA2. That is, the second display area DA2 may be larger than the first display area DA1.

In an embodiment, the first display area DA1 may correspond to a first portion of the first non-folding area NFA1, the folding area FA, and the second non-folding region NFA2, and the second display area DA2 may correspond to a second portion of the second non-folded area NFA2. That is, the first display area DA1 may be larger than the second display area DA2.

As illustrated in FIG. 4B, in a state in which the folding area FA is folded, the first display area DA1 may correspond to the first non-folding area NFA1, and the second display area DA2 may correspond to the folding areas FA and the second non-folding areas NFA2.

Although FIGS. 4A and 4B show the electronic device 10a having one folding area as an example of the electronic device, the present disclosure is not limited thereto. For example, the present disclosure can also be applied to an electronic device having two or more folding regions, a rollable electronic device, a slidable electronic device, or the like.

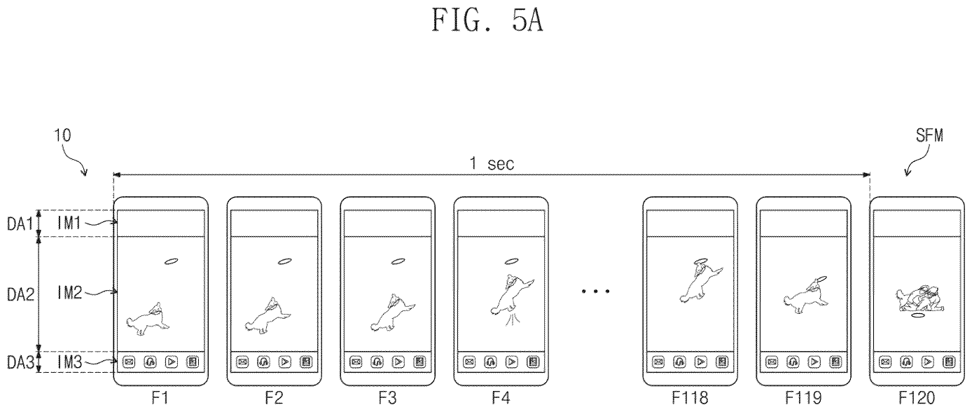

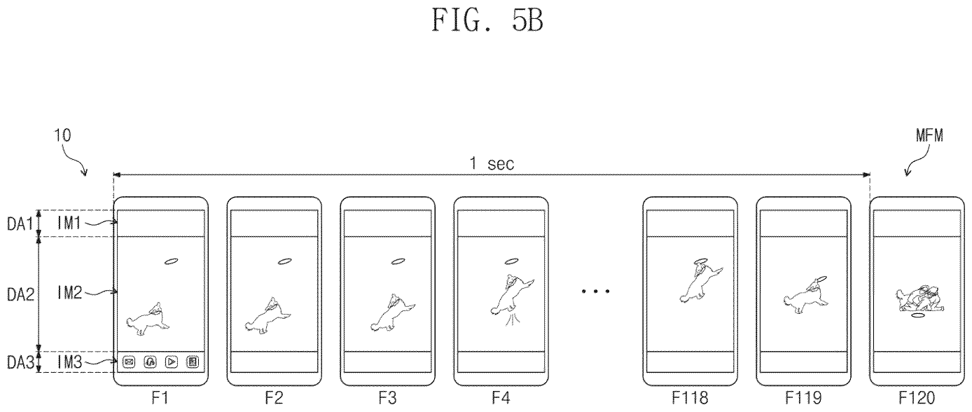

FIG. 5A is a diagram for explaining an operation of the electronic device 10 in the single frequency mode SFM.

Referring to FIG. 5A, the first image IM1 displayed in the first display area DA1 and the third display area DA3 may be a still image or an image having a long change period, and the second image IM2 displayed in the second display area DA2 may be a moving image. For example, the first display area DA1 may operate as a status bar, displaying indicators such as Wi-Fi signal strength, time, battery level, cellular reception, and notification icons. The second display area DA2 may operate as a main content area, presenting application interfaces, media content, or other user-interactive elements. The third display area DA3 may operate as a navigation bar, providing access to recent apps, favorite apps, or system navigation controls. The first image IM1 and the second image IM2 illustrated in FIG. 5A are merely examples, and various images may be displayed on the electronic device 10.

In the single frequency mode SFM, a drive frequency of the first display area DA1, the second display area DA2, and the third display area DA3 of the electronic device 10 is base frequency. For example, the base frequency may be 120 Hz. In the single frequency mode SFM, each of the first display area DA1, the second display area DA2, and the third display area DA3 of the electronic device 10 may be provided with data signals corresponding to images of the first frame F1 to the 120th frame F120 for one second.

FIG. 5B is a diagram for explaining an operation of the electronic device 10 in the multi-frequency mode MFM.

Referring to FIG. 5B, in the multi-frequency mode MFM, the electronic device 10 may set the drive frequency of the first display area DA1 and the third display area DA3 in which the first image IM1, that is, the still image is displayed, as the first drive frequency, and set the drive frequency of the second display area DA2 in which the second image IM2, that is, the moving image is displayed, to a second drive frequency higher than the first drive frequency. In an embodiment, the first drive frequency may be 1 Hz and the second drive frequency may be 120 Hz. The first drive frequency and the second drive frequency may vary.

When the first drive frequency is 1 Hz and the second drive frequency is 120 Hz in the multi-frequency mode MFM, a data signal corresponding to the second image IM2 in each of the first frame F1 to the 120th frame F120 may be provided to the second display area DA2 of the electronic device 10 for one second. The first display area DA1 and the third display area DA3 may be provided with data signals corresponding to the first image IM1 only in the first frame F1. That is, since a new data signal is not provided to the first display area DA1 and the third display area DA3 in the second to 120th frames F2 to F120, the same first image IM1 as the first frame F1 may be displayed on the electronic device 10 during the second to 120th frames F2-F120.

FIG. 5B exemplarily illustrates a case where the first drive frequency is 1 Hz and the second drive frequency is 120 Hz in the multi-frequency mode MFM, but the present disclosure is not limited thereto. The first drive frequency may be variously changed to a frequency lower than the second drive frequency, for example, 60 Hz, 30 Hz, 10 Hz, or the like.

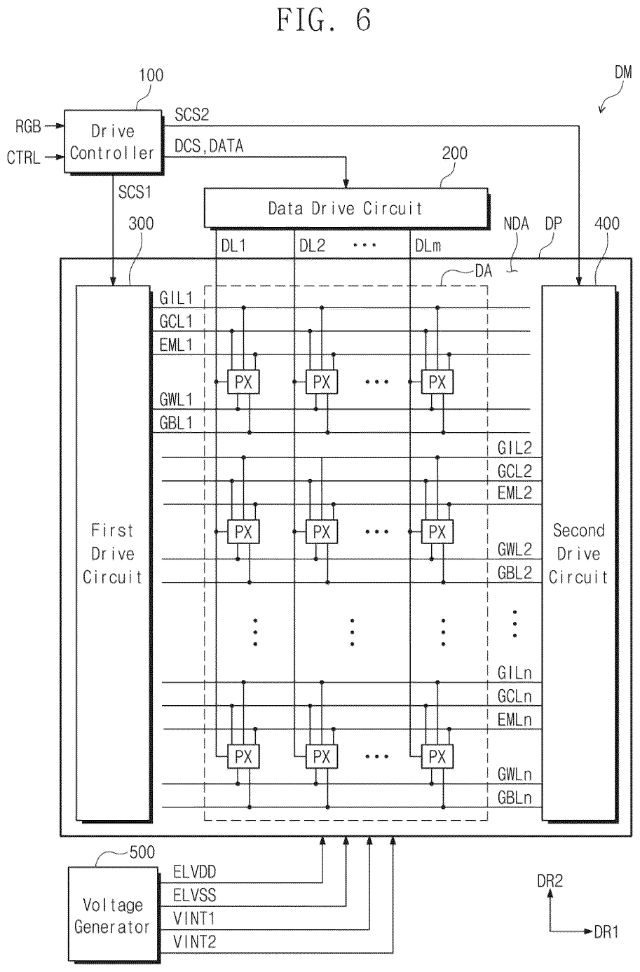

FIG. 6 is a block diagram of the display module DM according to an embodiment of the present disclosure.

Referring to FIG. 6, the display module DM includes a display panel DP, a drive controller 100, a data drive circuit 200, a first drive circuit 300, a second drive circuit 400, and a voltage generator 500.

The drive controller 100 receives an image signal RGB and a control signal CTRL. In an embodiment, the image signal RGB and the control signal CTRL may be provided from the processor PP illustrated in FIG. 1. The drive controller 100 outputs an output image signal DATA, a first scan control signal SCS1, a second scan control signal SCS2, a data control signal DCS, and a light emission control signal ECS corresponding to the image signal RGB and the control signal CTRL.

The drive controller 100 according to an embodiment of the present disclosure may set the operation mode to a single frequency mode or a multi-frequency mode based on at least one of the image signals RGB and the control signal CTRL. The drive controller 100 may output the output image signal DATA, the first scan control signal SCS1, the second scan control signal SSC2, the data control signal DCS, and the light emission control signal ECS corresponding to the determined operation mode.

The display panel DP includes a display area DA and a non-display area NDA. The display panel DP may include pixels PX arranged in the display area DA. In an embodiment, the first drive circuit 300 and the second drive circuit 400 may be arranged on the display panel DP.

The display panel DP includes scan lines GIL1-GILn, GCL1-GCLn, GWL1-GWLn, and GBL1-GBLn, light emission control lines EML1-EMLn, data lines DL1-DLm, and the pixels PX.

The scan lines GIL1-GILn, GCL1-GCLn, GWL1-GWLn, and GBL1-GBLn and the light emission control lines EML1-EMLn are spaced apart from each other in the second direction DR2. The data lines DL1-DLm extend from the data drive circuit 200 in a direction opposite to the second direction DR2, and are spaced apart from each other in the first direction DR1.

The data drive circuit 200 receives the data control signal DCS and the output image signal DATA from the drive controller 100. The data drive circuit 200 converts the output image signal DATA into data signals D1-Dm, and outputs the data signals D1-Dm to the plurality of data lines DL1-DLm to be described later. The data signals are analog voltages corresponding to a grayscale value of the output image signal DATA.

The voltage generator 500 generates voltages required for operation of the display panel DP. In this embodiment, the voltage generator 500 generates a first driving voltage ELVDD, a second driving voltage ELVSS, a first initialization voltage VINT1, and a second initialization voltage VINT2.

The first drive circuit 300 is arranged on a first side of the display panel DP. Among the scan lines GIL1-GILn, GCL1-GCLn, GWL1-GWLn, and GBL1-GBLn, the first scan lines GIL1, GCL1, GWL1, and GBL1 and the first light emission control line EML1 extend from the first drive circuit 300 in the first direction DR1.

The second drive circuit 400 is arranged on a second side of the display panel DP. Among the scan lines GIL1-GILn, GCL1-GCLn, GWL1-GWLn, and GBL1-GBLn, the second scan lines GIL2, GILn, GCl2, GCLn, GWL2, GWLn, GBL2, and GBLn and the second light emission control line EML2 extend from the second drive circuit 400 in a direction opposite to the first direction DR1.

In an embodiment, the first drive circuit 300 and the second drive circuit 400 are spaced apart from each other with the display area DA of the display panel DP interposed therebetween, but the present disclosure is not limited thereto. The first drive circuit 300 and the second drive circuit 400 may be arranged adjacent to one side of the display panel DP.

In an embodiment, the first scan lines may include scan lines connected with pixels arranged in an odd-numbered rows of the scan lines GIL1-GILn, GCL1-GCLn, GWL1-GWLn, and GBL1-GBLn. The first light emission control line may include light emission control lines connected to pixels arranged in an odd-numbered rows of the light emission control lines EML1-EMLn.

In one embodiment, the second scan lines may include scan lines connected with pixels arranged in an even-numbered rows of the scan lines GIL1-GILn, GCL1-GCLn, GWL1-GWLn, and GBL1-GBLn. The second light emission control line may include light emission control lines connected to pixels arranged in an even-numbered rows of the light emission control lines EML1-EMLn.

In an embodiment, the first drive circuit 300 and the second drive circuit 400 are not arranged on the display panel DP and may be configured as separate integrated circuits.

The plurality of pixels PX are electrically connected to the scan lines GIL1-GILn, GCL1-GCLn, GWL1-GWLn, and GBL1-GBLn, the light emission control lines EML1-EMLn, and the data lines DL1-DLm, respectively. In one embodiment, each of the plurality of pixels PX may be electrically connected to four scan lines, one light emission control line, and one data line. For example, as shown in FIG. 6, the pixels of the first row may be connected to the scan lines GIL1, GCL1, GWL1, and GBL1 and the light emission control line EML1. In addition, the pixels of the j-th row may be connected to the scan lines GILj, GCLj, GWLj, and GBLj and the light emission control line EMLj. The pixels of the n-th row may be connected to the scan lines GILn, GCLn, GWLn, and GBLn and the light emission control line EMLn.

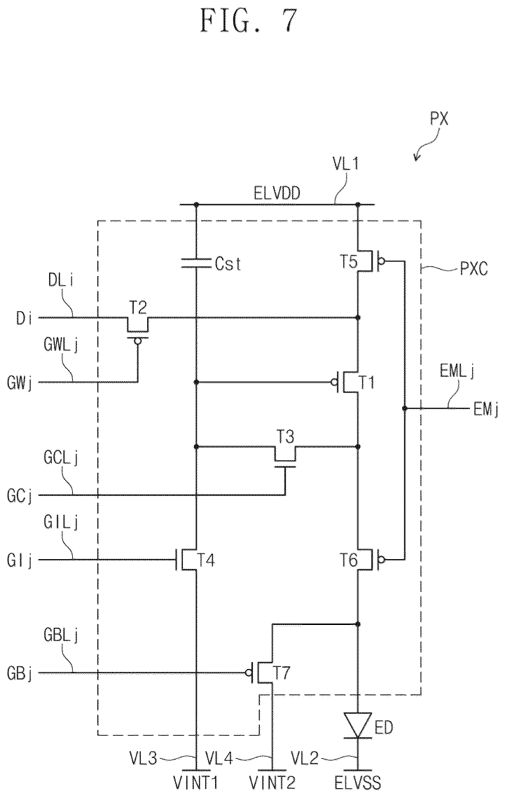

Each of the plurality of pixels PX includes a light-emitting element ED (see FIG. 7) and a pixel circuit PXC (see FIG. 7) that controls light emission of the light-emitting element. The pixel circuit PXC may include one or more transistors and one or more capacitors. The first drive circuit 300 and the light-emitting drive circuit EDC may include transistors formed through the same process as the transistors in the pixel circuit PXC.

Each of the plurality of pixels PX receives the first driving voltage ELVDD, the second driving voltage ELVSS, the first initialization voltage VINT1, and the second initialization voltage VINT2 from the voltage generator 500.

The first drive circuit 300 receives the first scan control signal SCS1 from the drive controller 100. In response to the first scan control signal SCS1, the first drive circuit 300 may output the first scan signals to the first scan lines GIL1, GCL1, GWL1, and GBL1, and may output the first control signal to the first light emission control line EML1.

The second drive circuit 400 receives the second scan control signal SCS2 from the drive controller 100. In response to the second scan control signal SCS2, the second drive circuit 400 may output the second scan signals to the second scan lines GIL2, GILn, GCL2, GCLn, GWL2, GWLn, GBL2, and GBLn, and may output the second light emission signal to the second light emission control line EML2.

The drive controller 100 according to an embodiment determines the operation mode based on the image signal RGB and the control signal CTRL. The drive controller 100 drives the display area DA at the base frequency (for example, 120 Hz) when the determined operation mode is the single frequency mode.

When the determined operation mode is the multi-frequency mode, the drive controller 100 may divide the display panel DP into two or more display regions, and set the drive frequency of each of the display regions.

FIG. 7 is a circuit diagram of a pixel PX according to an embodiment of the present disclosure.

FIG. 7 exemplarily illustrates the pixel PX connected to the i-th data line DLi among the data lines DL1-DLm illustrated in FIG. 6, the j-th scan lines GILj, GCLj, GWLj, and GBLj among the scan lines GIL1-GILn, GCL1-GCLn, GWL1-GWLn, and GBL1-GBLn, and the j-th light emission control line EMLj among the light emission control lines EML1-EMLn.

Each of the plurality of pixels PX illustrated in FIG. 6 may have the same circuit configuration as the pixel PX illustrated in FIG. 7. The pixel PX according to an embodiment includes a pixel circuit PXC and at least one light-emitting element ED. In an embodiment, the light-emitting element ED may be an organic light-emitting diode. The pixel circuit PXC includes first to seventh transistors T1, T2, T3, T4, T5, T6, and T7 and a capacitor Cst.

In this embodiment, the third and fourth transistors T3 and T4 among the first to seventh transistors T1 to T7 are N-type transistors having an oxide semiconductor as a semiconductor layer, and each of the first, second, fifth, sixth, and seventh transistors T1, T2, T5, T6, and T7 is a P-type transistor having a low-temperature polycrystalline silicon (LTPS) semiconductor layer. However, the present disclosure is not limited thereto. For example, all of the first to seventh transistors T1-T7 may be P-type transistors or N-type transistors. In another embodiment, at least one of the first to seventh transistors T1-T7 may be an N-type transistor, and the rest may be a P-type transistor. Note that the circuit configuration of the pixel according to the present disclosure is not limited to FIG. 5. The pixel circuit PXC illustrated in FIG. 5 is merely an example, and the configuration of the pixel circuit PXC may be modified and implemented.

The j-th scan lines GILj, GCLj, GWLj, and GBLj may respectively transmit the j-th scan signals GIj, GCj, GWj, and GBj. The light emission control line EMLj transmits a light emission signal EMj, and the i-th data line DLi transmits an i-th data signal Di. The data signal Di may have a voltage level corresponding to the image signal RGB input to the display module DM (see FIG. 6). The first to fourth driving voltage lines VL1, VL2, VL3, and VL4 may transmit the first driving voltage ELVDD, the second driving voltage ELVSS, the first initialization voltage VINT1, and the second initialization voltage VINT2.

The first transistor T1 includes a first electrode connected to the first driving voltage line VL1 via the fifth transistor T5, a second electrode electrically connected to an anode of the light-emitting element ED via the sixth transistor T6, and a gate electrode connected to one end of the capacitor Cst.

The second transistor T2 includes a first electrode connected to the data line DLi, a second electrode connected to the first electrode of the first transistor T1, and a gate electrode connected to the scan line GWLj. The second transistor T2 may be turned on according to the scan signal GWj transmitted through the scan line GWLj to transmit the data signal Di transmitted from the data line DLi to the first electrode of the first transistor T1.

In an embodiment, when the second transistor T2 is turned on, the data signal Di transmitted from the data line DLi may be transmitted to the first electrode of the first transistor T1. When the second transistor T2 is in the turned-off state, the data signal Di transmitted from the data line DLi cannot be transmitted to the first electrode of the first transistor T1.

The third transistor T3 includes a first electrode connected to the gate electrode of the first transistor T1, a second electrode connected to the second electrode of the first semiconductor transistor T1, and a gate electrode connected to the scan line GCLj. The third transistor T3 may be turned on according to the scan signal GCj received through the scan line GCLj to connect the gate electrode and the second electrode of the first transistor T1 to each other to diode-connect the first transistor T1.

The fourth transistor T4 includes a first electrode connected to the gate electrode of the first transistor T1, a second electrode connected to the third voltage line VL3 to which the first initialization voltage VINT1 is transmitted, and a gate electrode connected to the scan line GILj. The fourth transistor T4 may be turned on according to the scan signal GIj received through the scan line GILj to transmit the first initialization voltage VINT1 to the gate electrode of the first transistor T1 to perform an initialization operation of initializing the voltage of the gate electrode of first transistor T1.

The fifth transistor T5 includes a first electrode connected to the first driving voltage line VL1, a second electrode connected to the first electrode of the first transistor T1, and a gate electrode connected to the light emission control line EMLj.

The sixth transistor T6 includes a first electrode connected to the second electrode of the first transistor T1, a second electrode connected to the anode of the light-emitting element ED, and a gate electrode connected to the light-emitting control line EMLj.

The fifth transistor T5 and the sixth transistor T6 may be simultaneously turned on according to the light emission signal EMj received through the light emission control line EMLj, and through this, the first driving voltage ELVDD may be compensated through the diode-connected first transistor T1 and transmitted to the light emitting element ED.

The seventh transistor T7 includes a first electrode connected to the second electrode of the sixth transistor T6, a second electrode connected to the fourth voltage line VL4, and a gate electrode connected to the scan line GBLj. The seventh transistor T7 is turned on according to the scan signal GBj received through the scan line GBLj to bypass the current of the anode of the light-emitting element ED to the fourth voltage line VL4.

One end of the capacitor Cst is connected to the gate electrode of the first transistor T1, and the other end is connected to the first driving voltage line VL1.

The light-emitting element ED is electrically connected to the second electrode of the first transistor T1 through the sixth transistor T6. A cathode of the light-emitting element ED may be connected to the second driving voltage line VL2 that transmits the second driving voltage ELVSS. The structure of the pixel PX according to an embodiment is not limited to the structure illustrated in FIG. 7, and the number of transistors, the number of capacitors, and the connection relationship included in one pixel PX can be variously modified. The scan lines GWLj, GCLj, GILj, and GBLj connected to the second, third, fourth, and seventh transistors T2, T3, T4, and T7 are merely examples, and may receive different scan signals.

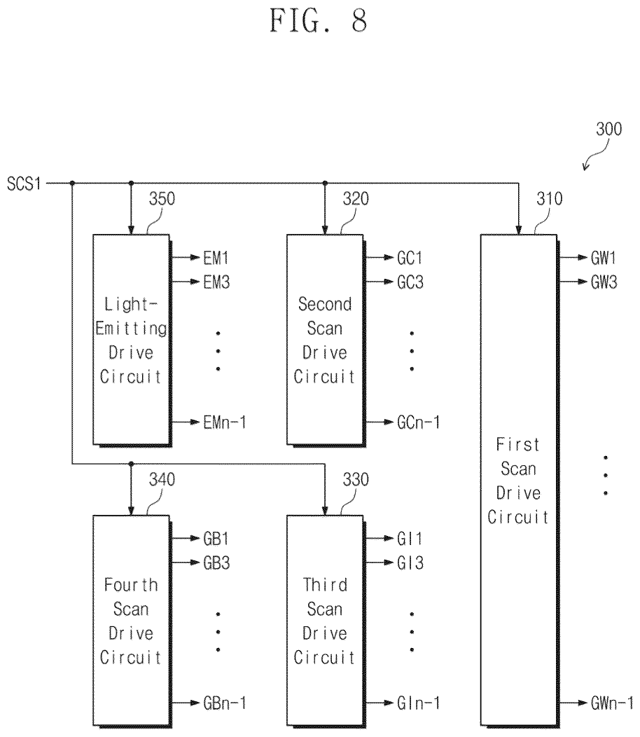

FIG. 8 is a block diagram illustratively showing the first drive circuit 300 shown in FIG. 6.

Referring to FIG. 8, the first drive circuit 300 includes a first scan drive circuit 310, a second scan drive circuit 320, a third scan drive circuit 330, a fourth scan drive circuit 340, and a light-emitting drive circuit 350.

The first scan drive circuit 310 outputs the first scan signals GW1, GW3, . . . , and GWn-1 in response to the first scan control signal SCS1. The first scan signals GW1, GW3, . . . , and GWn-1 may be provided to odd-numbered scan lines among the scan lines GWL1-GWLn.

The second scan drive circuit 320 outputs the first scan signals GC1, GC3, . . . , and GCn-1 in response to the first scan control signal SCS1. The first scan signals GC1, GC3, ..., and GCn-1 may be provided to odd-numbered scan lines among the scan lines GCL1-GCLn.

The third scan drive circuit 330 outputs the first scan signals GI1, GI3, . . . , and GIn-1 in response to the first scan control signal SCS1. The first scan signals GI1, GI3, . . . , and GIn-1 may be provided to odd-numbered scan lines among the scan lines GIL1-GILn.

The fourth scan drive circuit 340 outputs the first scan signals GB1, GB3, . . . , and GBn-1 in response to the first scan control signal SCS1. The first scan signals GB1, GB3, . . . , and GBn-1 may be provided to odd-numbered scan lines among the scan lines GBL1-GBLn.

The light-emitting drive circuit 350 outputs the first light-emitting signals EM1, EM3, . . . , and EMn-1 in response to the first scan control signal SCS1. The first light-emitting signals EM1, EM3, . . . , and EMn-1 may be provided as odd-numbered scan lines among the light-emitting control lines EML1-EMLn.

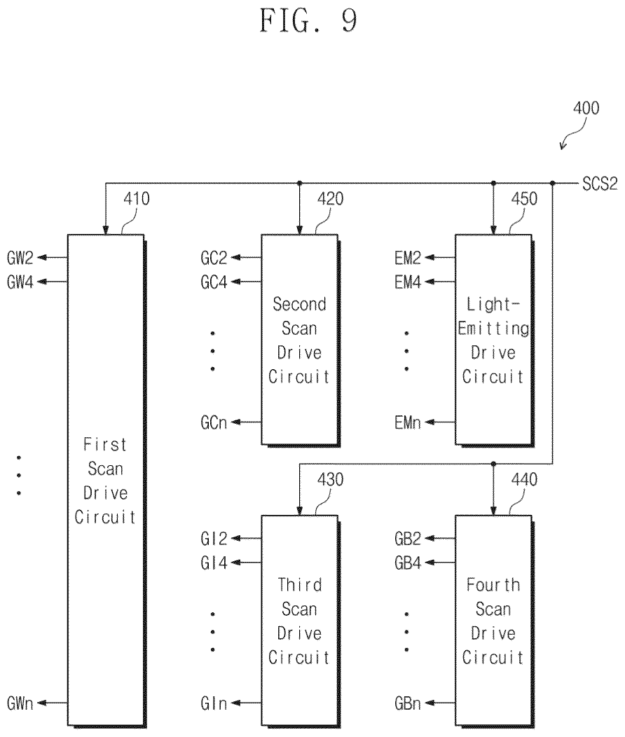

FIG. 9 is a block diagram illustratively showing the second drive circuit 400 shown in FIG. 6.

Referring to FIG. 9, the second drive circuit 400 includes a first scan drive circuit 410, a second scan drive circuit 420, a third scan drive circuit 430, a fourth scan drive circuit 440, and a light-emitting drive circuit 450.

The first scan drive circuit 410 outputs the second scan signals GW2, GW4, . . . , and GWn in response to the second scan control signal SCS2. The second scan signals GW2, GW4, . . . , and GWn may be provided as even-numbered scan lines among the scan lines GWL1-GWLn.

The second scan drive circuit 420 outputs the second scan signals GC2, GC4, . . . , and GCn in response to the second scan control signal SCS2. The second scan signals GC2, GC4, . . . , and GCn may be provided as even-numbered scan lines among the scan lines GCL1-GCLn.

The third scan drive circuit 430 outputs the second scan signals GI2, GI4, . . . , and GIn in response to the second scan control signal SCS2. The second scan signals GI2, GI4, . . . , and GIn may be provided to even-numbered scan lines among the scan lines GIL1-GILn.

The fourth scan drive circuit 440 outputs the second scan signals GB2, GB4, . . . , and GBn in response to the second scan control signal SCS2. The second scan signals GB2, GB4, . . . ., and GBn may be provided as even-numbered scan lines among the scan lines GBL1-GBLn.

The light-emitting drive circuit 450 outputs the second light-emitting signals EM2, EM4, . . . , and EMn in response to the second scan control signal SCS2. The second light-emitting signals EM2, EM4, . . . , and EMn may be provided as even-numbered scan lines among the light-emitting control lines EML1-EMLn.

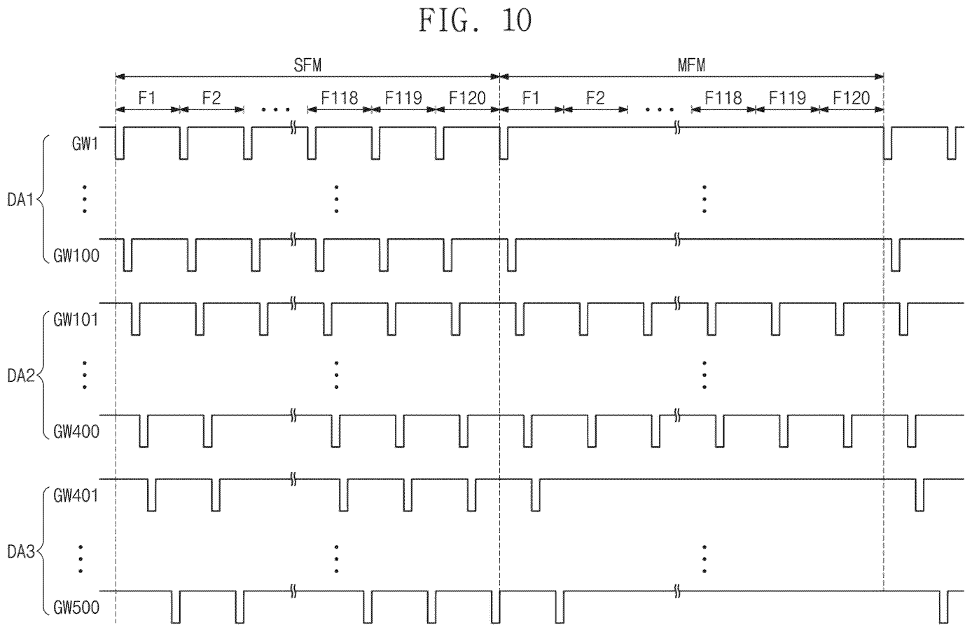

FIG. 10 exemplarily shows scan signals GW1-GW500 in the single frequency mode (SFM) and the multi-frequency mode (MFM).

Although 500 scan signals GW1-GW500 are exemplarily shown in FIG. 9, the present disclosure is not limited thereto. The number of the scan signals GW1-GW500 may be variously changed according to the size, resolution, and the like of the display panel DP.

Referring to FIGS. 3, 6, and 10, in an embodiment, the frequency of the scan signals GW1-GW500 in the single frequency mode SFM is 120 Hz.

During the single frequency mode SFM, the scan signals GW1-GW500 may be sequentially activated to a low level in each of the first frame F1 to the 120th frame F120.

In an embodiment, among the scan signals GW1-GW500 during the multi-frequency mode MFM, the scan signals GW1-GW100 may correspond to the first display area DA1 of the electronic device 10, the scan signals GW101-GW400 may correspond to the second display area DA2, and the scan signals GW401-GW500 may correspond to the third display area DA3.

During the multi-frequency mode MFM, the scan signals GW1-GW100 and GW401-GW500 may be sequentially activated to a low drive frequency level (e.g., a predetermined low frequency level or a predetermined low frequency range) in the first frame F1. The scan signals GW1-GW100 and GW401-GW500 may be maintained at a high drive frequency level (e.g., a predetermined high frequency level or a predetermined high frequency range) during the second to 120th frames F2-F120.

The scan signals GW101-GW400 may be sequentially activated at a low level in each of the first frame F1 to the 120th frame F120. That is, the frequency of the scan signals GW1-GW200 and GW301-GW500 during the multi-frequency mode MFM is 1 Hz, and the frequency of the scan signals GW101-GW400 is 120 Hz.

Therefore, the frequency of the scan signals GW101-GW400 corresponding to the second display area DA2 in which the moving image is displayed may be the second drive frequency (for example, 120 Hz), and the frequency of the scanning signals GW1-GW100 and GW401-GW500 corresponding to the first display area DA1 and the third display area DA3 in which the still image is displayed may also be the first drive frequency (for instance, 1 Hz). The display quality of the moving image may be maintained as the second display area DA2 in which the moving image is displayed is driven at the second drive frequency. Since the first display area DA1 and the third display area DA3 in which the still image is displayed are driven at a first drive frequency lower than the second drive frequency, power consumption may be reduced.

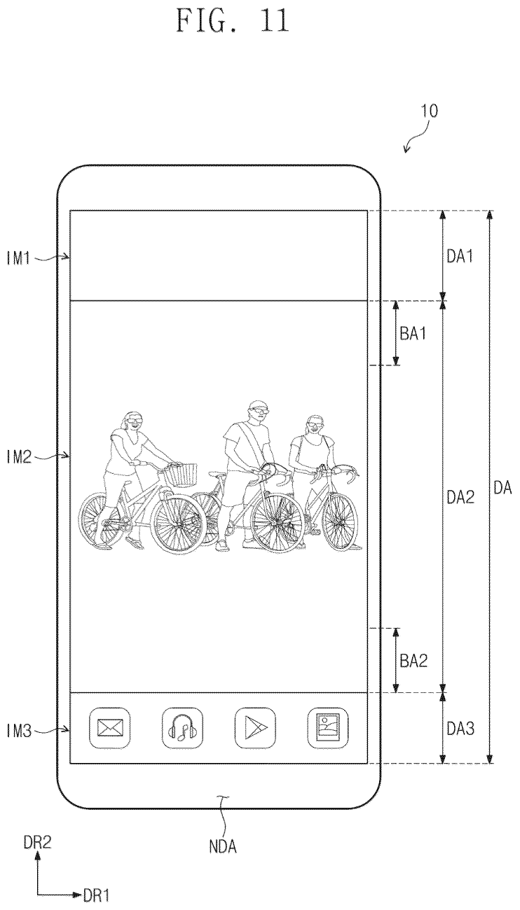

FIG. 11 shows an electronic device 10 according to an embodiment of the present disclosure.

Referring to FIG. 11, the second display area DA2 in which a moving image is displayed includes a first boundary area BA1 adjacent to the first display area DA1 and a second boundary area BA2 adjacent to the second display area DEA2. The first boundary area BA1 within the second display area DA2 may have a boundary in contact with the boundary of the first display area DA1, and may have a height less than that of the first display area DA1. The second boundary area BA2 within the second display area DA2 may have a boundary in contact with the boundary of the third display area DA3, and may have a height less than that of the third display area DA3.

In an embodiment, the drive frequency of the first boundary area BA1 may be any one of a first drive frequency, a second drive frequency, and a third drive frequency. The drive frequency of the second boundary area BA2 may be any one of a first drive frequency, a second drive frequency, and a fourth drive frequency. In an embodiment, each of the third drive frequency and the fourth drive frequency may be a frequency between the first drive frequency and the second drive frequency. In an embodiment, the third drive frequency and the fourth drive frequency may be equal to or different from each other.

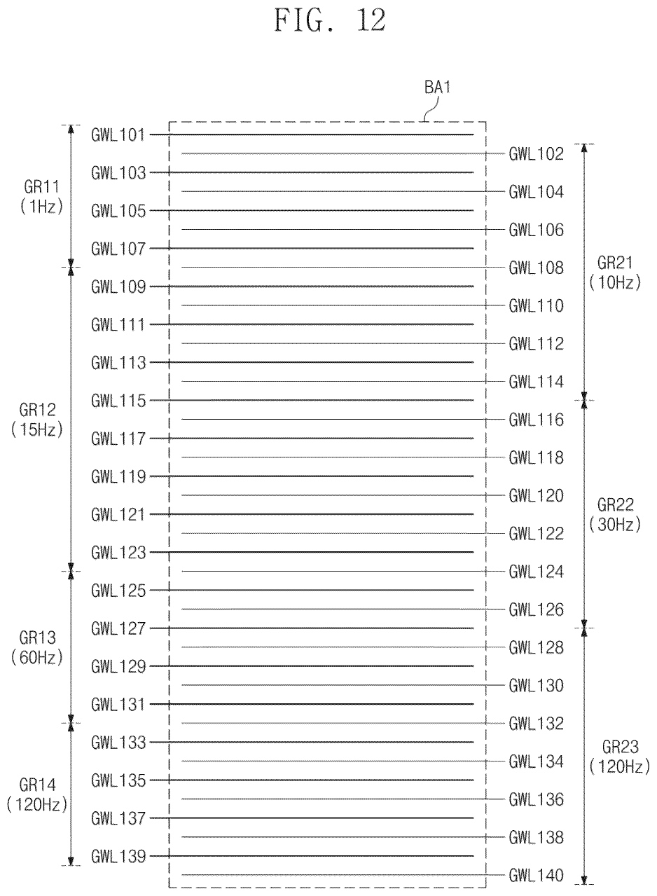

FIG. 12 exemplarily shows scan lines GWL101-GWL140 arranged in the first boundary region BA1.

FIG. 12 illustrates that forty (40) scan lines GWL101-GWL140 are arranged in the first boundary area BA1, but the present disclosure is not limited thereto. The number of scan lines arranged in the first boundary area BA1 may be variously changed.

Referring to FIGS. 6, 11 and 12, the odd-numbered scan lines GWL101, GWL103, . . . , and GWL139 among the scan lines GWL 101-GWL140 are electrically connected to the first drive circuit 300. The even-numbered scan lines GWL102, GWL104, . . . , and GWL140 among the scan lines GWL101-GWL140 are electrically connected to the second drive circuit 400.

In the following description, the odd-numbered scan lines GWL101, GWL103, . . . , and GWL139 are referred to as first scan lines, and the even-numbered scan line GWL102, GWL104, . . . , and GWL140 are referred to as second scan lines.

The first drive circuit 300 divides the first scan lines GWL101, GWL103, . . . , and GWL139 into a plurality of first groups GR11, GR12, GR13 and GR14 during the multi-frequency mode. The first drive circuit 300 may set a drive frequency of each of the plurality of first groups GR11, GR12, GR13, and GR14.

In an embodiment, the driving frequencies of each of the plurality of first groups GR11, GR12, GR13, and GR14 may be different from each other. In an embodiment, the drive frequency of each of the plurality of first groups GR11, GR12, GR13, and GR14 may be set within a range from the first drive frequency of the first display area DA1 to the second drive frequency of the second display area DA2.

In the example shown in FIG. 12, the first group GR11 includes the first scan lines GWL101-GWL107, the first group GR12 includes the first scan line GWL109-GWL123, the first group GB13 includes the first scan lines GWL125-GWL131, and the first group GR14 includes the first scan lines GWL133-GWL139.

In the example shown in FIG. 12, the second group GR21 includes the second scan lines GWL102-GWL114, the second group GR22 includes the second scan lines GWL116-GWL126, and the second group GR23 includes the second scan line GWL128-GWL140.

The first drive circuit 300 may set the driving frequencies of the first groups GR11, GR12, GR13, and GR14 to 1 Hz, 15 Hz, 60 Hz, and 120 Hz, respectively.

The second drive circuit 400 may set driving frequencies of the second groups GR21, GR22, and GR23 to 10 Hz, 30 Hz, and 120 Hz, respectively.

The number of first groups and the drive frequency of each of the first groups may vary. Further, the number of second groups and the drive frequency of each of the second groups may be variously changed.

For example, when the drive frequency of the first display area DA1 is 1 Hz and the drive frequency of a second display area DA2 is 120 Hz, the drive frequency of each of the first groups GR11, GR12, GR13, and GR14 and the second groups GR21, GR22, and GR23 may be any one of 1 Hz, 10 Hz, 15 Hz, 24 Hz, 30 Hz, 60 Hz, and 120 Hz.

In an embodiment, when the second drive frequency of the second display area DA2 is higher than the first drive frequency of the first display area DA1, the driving frequencies of each of the first groups GR11, GR12, GR13, and GR14 and the second groups GR21, GR22, and GR23 gradually increase toward a direction opposite to the second direction DR2.

The scan lines of the second boundary region BR2 during the multi-frequency mode may also be driven in the same manner as the scan lines of the first boundary region BA1.

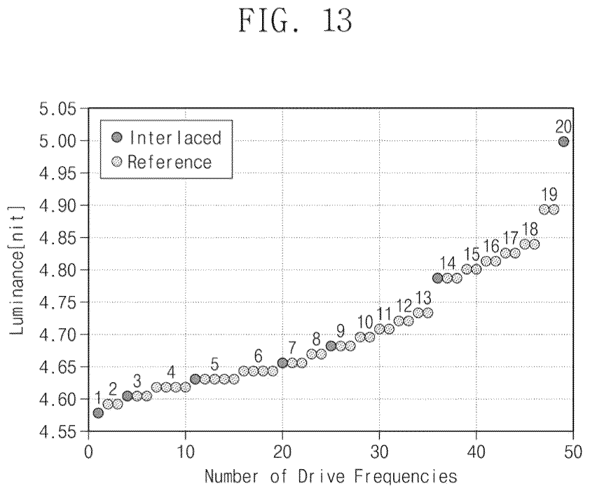

FIG. 13 is a graph illustratively showing the luminance of the first boundary region BA1 according to the drive frequency of each of the first groups and the second groups of the first boundary area BA1.

In FIG. 13, the horizontal axis of the graph represents cases of a combination of driving frequencies, and the vertical axis represents luminance of the first boundary area BA1.

Referring to FIGS. 6, 11, and 13, the first scan lines GWL101-GWL139 of the first boundary area BA1 are divided into seven first groups, and the drive frequency of each of the seven first groups may be any one of 1 Hz, 10 Hz, 15 Hz, 24 Hz, 30 Hz, 60 Hz, and 120 Hz.

The second scan lines GWL102-GWL140 of the second boundary area BR2 are divided into seven second groups, and the drive frequency of each of the seven second groups may be any one of 1 Hz, 10 Hz, 15 Hz, 24 Hz, 30 Hz, 60 Hz, and 120 Hz.

Theoretically, a combination of seven drive frequencies of each of the first groups and seven drive frequencies of the each of the second groups may produce up to 49 drive frequency combinations (7×7).

FIG. 13 exemplarily shows luminance of the first boundary area BA1 according to various combinations of driving frequencies in an actual operating environment. The luminance of the first boundary area BA1 varies from a minimum of 455 nits to 500 nits depending on the specific drive frequency combination. In FIG. 13, twenty distinct luminance levels are observed in the first boundary area BA1 (see luminance levels 1 through 20 marked on the luminance values).

Referring again to FIG. 11, even when images of the same luminance are displayed in the first display area DA1 and the second display area DA2, the driving frequencies applied to the first display area DEA1 and drive frequency applied to the second display area DA2 may be different. When the drive frequency difference lasts for a predetermined time or longer, a luminance deviation may become perceptible at a boundary between the first display area DA1 and the second display area DA2

According to an embodiment of the present disclosure, an interlaced drive frequency mixing method may be applied to reduce the visible luminance deviation. In this method, the drive frequency in the first boundary area BA1 is varied, such that different frequencies are applied to alternating scan lines (i.e., drive frequency of the first scan lines (the odd-numbered scan lines) and the drive frequency of second scan lines (the even-numbered scan line). As a result, the boundary between the first display region DA1 and the second display region DA2 appears visually blended or blurred. Therefore, a luminance difference between the first display area DA1 and the second display area DA2 may be less noticeable to by the user.

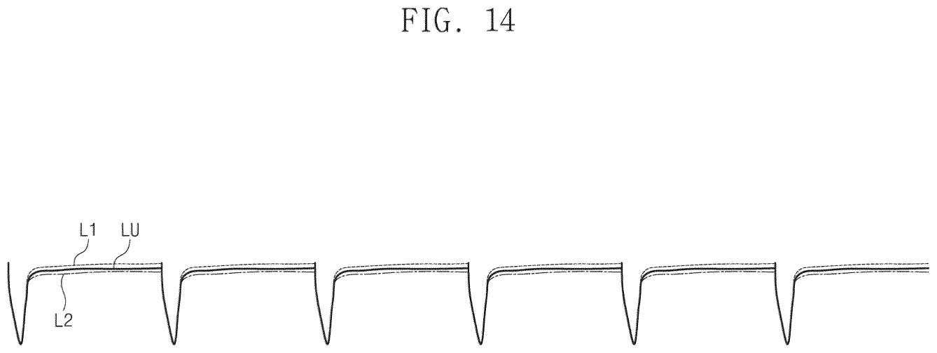

FIG. 14 exemplarily shows the luminance of the first boundary area BA1 when the first scan lines GWL101, GWL103, . . . , and GWL139 and the second scan lines GWL102, GWL104, . . . , and GWL140 are driven in the manner shown in FIG. 12.

In FIG. 14, the first curve L1 is a luminance of pixels PX connected to the first scan lines GWL101, GWL103, . . . , and GWL139 among the pixels PX illustrated in FIG. 6. The second curve L2 is the luminance of the pixels PX connected to the second scan lines GWL102, GWL104, . . . , and GWL140 among the pixels PX illustrated in FIG. 6.

Since drive frequency of the first scan lines GWL101, GWL103, . . . , and GWL139 and drive frequency of the second scan lines GWL102, GWL104, . . . , and GWL140 are different from each other, luminance indicated by the first curve L1 and luminance indicated by the second curve L2 may be different from each other.

The user cannot distinguish between the luminance of the pixels PX connected to the first scan lines GWL101, GWL103, . . . , and GWL139 and the luminance of the pixels TX connected to the second scan lines GWL102, GWL104, . . . , and GWL140, and recognizes an intermediate luminance such as the third curve LU as the luminance in the first boundary area BA1.

The display module of the electronic device having a configuration describe above may reduce power consumption by lowering a drive frequency of a display region in which a still image is displayed. In particular, a luminance difference due to a frequency difference at a boundary between a region where a still image is displayed and a region where a moving image is displayed is prevented from being perceived by a user. Therefore, the display quality of the electronic device can be improved.

In one or more embodiments, a display module may include: a display panel including a plurality of pixels respectively connected to a plurality of data lines and a plurality of scan lines; a data drive circuit configured to drive the plurality of data lines; a first scan drive circuit configured to drive a first plurality of scan lines of the plurality of scan lines; and a second scan drive circuit configured to drive a plurality of second scan lines of the plurality of scan lines. During a multi-frequency mode, the display panel is divided into a first display region driven at a first drive frequency and a second display region driven at the second drive frequency, the first scan drive circuit is configured to set a drive frequency of the first plurality of scan lines in a boundary area of the second display region to a third drive frequency, and the second scan drive circuit is configured to set a drive frequency of the second plurality of scan lines in the boundary area to a fourth drive frequency.

The third drive frequency may be different from the fourth drive frequency.

The third drive frequency may be in a range from the first drive frequency to the second drive frequency, and the fourth drive frequency may be in a range from the first drive frequency to the second drive frequency.

The first scan drive circuit may be configured to divide the first plurality of scan lines in the boundary area into a plurality of first groups, and set the third drive frequency of each of the plurality of first groups differently.

Based on the second drive frequency being higher than the first drive frequency, the third drive frequency of each of the plurality of first groups may increase in a stepwise manner as distance between the first display region and each of the first groups increases.

The second scan drive circuit may be configured to divide the second plurality of scan lines in the boundary area into a plurality of second groups, and set a drive frequency of each of the plurality of second groups differently.

Based on the second drive frequency being higher than the first drive frequency, the fourth drive frequency of each of the plurality of second groups increases in a stepwise manner as distance between the first display region and each of the second groups increases.

The first plurality of scan lines and the second plurality of scan lines may be alternately arranged.

The display panel may include: a display region including the first display region and the second display region; and a non-display area in which the first scan drive circuit and the second scan drive circuit are arranged.

The first scan drive circuit and the second scan drive circuit may be spaced apart from each other with the first display region and the second display region interposed therebetween.

In one or more embodiments, an electronic device may include: a processor configured to provide an image signal and a control signal; and a display module configured to determine an operation mode based on the image signal and the control signal, and display an image according to the operation mode, wherein the display module includes: a display panel including a plurality of pixels respectively connected to a plurality of data lines and a plurality of scan lines; a data drive circuit configured to drive the plurality of data lines; a first scan drive circuit configured to drive a first plurality of scan lines of the plurality of scan lines; a second scan drive circuit configured to drive a second plurality of scan lines of the plurality of scan lines, and a drive controller configured to control the data drive circuit, the first scan drive circuit, and the second scan drive circuit based on the image signal and the control signal. Based on the operating mode being a multi-frequency mode: the display panel is divided into a first display region driven at a first drive frequency and a second display region driven at the second drive frequency, the first scan drive circuit is configured to set a drive frequency of the first plurality of scan lines in a boundary area of the second display region to a third drive frequency, and the second scan drive circuit is configured to set a drive frequency of the second plurality of scan lines in the boundary area to a fourth drive frequency.

The first plurality of scan lines and the second plurality of scan lines may be alternately arranged.

The third drive frequency may be different from the fourth drive frequency.

The first scan drive circuit may be configured to divide the first plurality of scan lines in the boundary area into a plurality of first groups, and set the third drive frequency of each of the plurality of first groups differently.

When the second drive frequency is higher than the first drive frequency, the third drive frequency of each of the plurality of first groups may increase in a stepwise manner as distance between the first display region and each of the first groups increases.

The second scan drive circuit may be configured to divide the second plurality of scan lines in the boundary area into a plurality of second groups, and set a drive frequency of each of the plurality of second groups differently.

Based on the second drive frequency being higher than the first drive frequency, the fourth drive frequency of each of the plurality of second groups may increase in a stepwise manner as distance between the first display region and each of the second groups increases.

The third drive frequency may be in a range from the first drive frequency to the second drive frequency, and the fourth drive frequency may be in a range from the first drive frequency to the second drive frequency.

The display panel may include: a display region including the first display region and the second display region; and a non-display area in which the first scan drive circuit and the second scan drive circuit are arranged.

The first scan drive circuit and the second scan drive circuit may be spaced apart from each other with the display region interposed therebetween.

While the present disclosure has been described above with reference to preferred embodiments thereof, it will be understood by those skilled in the art or those skilled in the relevant art that various modifications and changes can be made to the present disclosure without departing from the spirit and technical scope of the present disclosure as set forth in the following claims. Therefore, the technical scope of the present disclosure should not be limited to the contents described in the detailed description of the specification, but should be determined by the claims.

What is claimed is:

1. A display module comprising:
a display panel including a plurality of pixels respectively connected to a plurality of data lines and a plurality of scan lines;
a data drive circuit configured to drive the plurality of data lines;
a first scan drive circuit configured to drive a first plurality of scan lines of the plurality of scan lines; and
a second scan drive circuit configured to drive a plurality of second scan lines of the plurality of scan lines,
wherein during a multi-frequency mode:
the display panel is divided into a first display region driven at a first drive frequency and a second display region driven at the second drive frequency,
the first scan drive circuit is configured to set a drive frequency of the first plurality of scan lines in a boundary area of the second display region to a third drive frequency, and
the second scan drive circuit is configured to set a drive frequency of the second plurality of scan lines in the boundary area to a fourth drive frequency.

2. The display module of claim 1, wherein the third drive frequency is different from the fourth drive frequency.

3. The display module of claim 1, wherein the third drive frequency is in a range from the first drive frequency to the second drive frequency, and
wherein the fourth drive frequency is in a range from the first drive frequency to the second drive frequency.

4. The display module of claim 3, wherein the first scan drive circuit is configured to divide the first plurality of scan lines in the boundary area into a plurality of first groups, and set the third drive frequency of each of the plurality of first groups differently.

5. The display module of claim 4, wherein based on the second drive frequency being higher than the first drive frequency, the third drive frequency of each of the plurality of first groups increases in a stepwise manner as distance between the first display region and each of the first groups increases.

6. The display module of claim 3, wherein the second scan drive circuit is configured to divide the second plurality of scan lines in the boundary area into a plurality of second groups, and set a drive frequency of each of the plurality of second groups differently.

7. The display module of claim 6, wherein based on the second drive frequency being higher than the first drive frequency, the fourth drive frequency of each of the plurality of second groups increases in a stepwise manner as distance between the first display region and each of the second groups increases.

8. The display module of claim 1, wherein the first plurality of scan lines and the second plurality of scan lines are alternately arranged.

9. The display module of claim 1, wherein the display panel includes:
a display region including the first display region and the second display region; and
a non-display area in which the first scan drive circuit and the second scan drive circuit are arranged.

10. The display module of claim 1, wherein the first scan drive circuit and the second scan drive circuit are spaced apart from each other with the first display region and the second display region interposed therebetween.

11. An electronic device comprising:
a processor configured to provide an image signal and a control signal; and
a display module configured to determine an operation mode based on the image signal and the control signal, and display an image according to the operation mode, wherein the display module includes:
a display panel including a plurality of pixels respectively connected to a plurality of data lines and a plurality of scan lines;
a data drive circuit configured to drive the plurality of data lines;
a first scan drive circuit configured to drive a first plurality of scan lines of the plurality of scan lines;
a second scan drive circuit configured to drive a second plurality of scan lines of the plurality of scan lines, and
a drive controller configured to control the data drive circuit, the first scan drive circuit, and the second scan drive circuit based on the image signal and the control signal,
wherein based on the operating mode being a multi-frequency mode:
the display panel is divided into a first display region driven at a first drive frequency and a second display region driven at the second drive frequency,
the first scan drive circuit is configured to set a drive frequency of the first plurality of scan lines in a boundary area of the second display region to a third drive frequency, and
the second scan drive circuit is configured to set a drive frequency of the second plurality of scan lines in the boundary area to a fourth drive frequency.

12. The electronic device of claim 11, wherein the first plurality of scan lines and the second plurality of scan lines are alternately arranged.

13. The electronic device of claim 11, wherein the third drive frequency is different from the fourth drive frequency.

14. The electronic device of claim 11, wherein the first scan drive circuit is configured to divide the first plurality of scan lines in the boundary area into a plurality of first groups, and set the third drive frequency of each of the plurality of first groups differently.

15. The electronic device of claim 14, wherein when the second drive frequency is higher than the first drive frequency, the third drive frequency of each of the plurality of first groups increases in a stepwise manner as distance between the first display region and each of the first groups increases.

16. The electronic device of claim 11, wherein the second scan drive circuit is configured to divide the second plurality of scan lines in the boundary area into a plurality of second groups, and set a drive frequency of each of the plurality of second groups differently.

17. The electronic device of claim 16, wherein based on the second drive frequency being higher than the first drive frequency, the fourth drive frequency of each of the plurality of second groups increases in a stepwise manner as distance between the first display region and each of the second groups increases.

18. The electronic device of claim 11, wherein the third drive frequency is in a range from the first drive frequency to the second drive frequency, and
wherein the fourth drive frequency is in a range from the first drive frequency to the second drive frequency.

19. The electronic device of claim 11, wherein the display panel includes:
a display region including the first display region and the second display region; and
a non-display area in which the first scan drive circuit and the second scan drive circuit are arranged.

20. The electronic device of claim 19, wherein the first scan drive circuit and the second scan drive circuit are spaced apart from each other with the display region interposed therebetween.
